(19) United States
(12) Patent Application Publication
(10) Pub. No.: US 2002/0116078 A1
(43) Pub. Date: Aug. 22, 2002

(54) Control method of open type motion simulation system

(75) Inventors: Fu-Hsieng Lee, Kaohsiung (TW); David Lai, Kaohsiung (TW); Chang-Rong Tsai, Taipei (TW)

Correspondence Address: BACON & THOMAS, 4th Floor, 625 Slaters Lane, Alexandria, VA, 22314-1176, US

(73) Assignee: Best System Inc., Kaohsiung (TW)

(21) Appl. No.: 09/785,288

(22) Filed: Feb. 20, 2001

(51) Int. Cl. G05B 13/02; G06F 7/60

(52) U.S. Cl. 700/31; 703/2

(57) ABSTRACT

A control method of an open type motion simulation system, the method includes the steps of: a simulation system linked to a motion system; the simulation system outputting open type command to the motion system; the motion system simultaneously performing operation and analysis on the open type command and platform feedback data by platform dynamic algorithm principle of a control ware; and the motion system then outputting control signal to a control driver to drive the platform.

### BACKGROUND OF THE INVENTION

1. Field of the Invention

The present invention relates to a control method of an open type motion simulation system, and more particularly to a motion system whose control ware uses platform dynamic algorithm principle to perform operation and analysis on the open type motion command of various simulation systems to be converted into signal to drive the motion platform of the motion system, which builds integrated open type command between the simulation system and the motion system of the simulator.

2. Description of the Related Prior Art

The simulation programs of a conventional simulation system include programs such as that of the wheeled vehicle, ship or flight vehicle. The simulation system mainly builds the program on the specific static system of image simulation, and the simulation system is not integrated with the motion platform. Thus, each motion platform needs a specified simulation system, or the simulation system can only be applied to a specified motion platform. The reason that the simulation system is not integrated with the motion platform is in that the cost and price of the motion platform are too expensive, which is mainly available for the exercise training, the national defense industry or the aerospace flight training, and whose technology of fabrication cannot be shifted to a common industry to be further developed. In addition, no one proceeds the integration to search for the united and regulated standard such that the system integrator does not know how to apply the integrated regulation and standard.

The conventional simulation device is disclosed in the U.S. Pat. No. 5,752,834, patented on May 19, 1998, which is a motion/force simulation device having six or three degree of freedom. FIG. 1 is a flow chart block diagram of a conventional motion/force simulation device having six or three degree of freedom in accordance with the U.S. Pat. No. 5,752,834. As shown in FIG. 1, the flow chart includes three blocks. The first block is a motion/force simulation system having six degrees of freedom, the second block is a mechanical device attached to the first block, and the third block is a video game processing unit. The user may use the control lever or operation lever to manipulate the simulation device, which, after being processed by the video game processing unit, outputs audio and video feedback to the user, and additionally outputs the commands such as velocity, vibration, acceleration, force etc. to the motion/force simulation system having six degrees of freedom. In the said simulation system, the commands such as the velocity, the vibration, the acceleration, the force etc. are converted into images, and the simulated displacement and orientation are output to the reverse displacement controller which outputs the length of the actuator to the mechanical device which outputs the simulated motion and force feedback to the user. The simulation system of the U.S. Pat. No. 5,752,834 mainly builds the program on the specific static system of an image simulation. Thus, the developers of the simulation system cannot amend original simulation program or develop new program especially for the single simulation system of the U.S. Pat. No. 5,752,834. If it needs to amend the original simulation program or to develop the new program, it has to take into consideration of the control of the motion platform, thereby forming the barrier of the program developers.

### SUMMARY OF THE INVENTION

With regard to this, the present invention is developed to improve the above-mentioned drawbacks, which mainly builds command integration between the simulation system and the motion system, so as to solve the problem in which the simulation system is not integrated with the motion platform. The present invention mainly includes a motion system whose control ware uses the platform dynamic algorithm principle to operate, process and analyze the motion command of different simulation systems, which are converted into the signal to drive the motion platform of the motion system, thereby building the command integration between the simulation system and the motion system of the simulator.

The primary objective of the present invention is to provide a control method of an open type motion simulation system, which is provided with a control ware on the motion system, the control ware includes a platform dynamic algorithm principle, which only needs to receive open type command of the simulation system to perform operation, so that command integration may be built between the simulation system and the motion system.

The secondary objective of the present invention is to provide a control method of an open type motion simulation system, which is provided with a control ware on the motion system, which only needs to receive open type command of the simulation system, so that the program developer only needs to pay attention to developing simulating or playing program without having to consider the mating operation of the motion platform.

The control method of an open type motion simulation system in accordance with the present invention control method of an open type motion simulation system, the method comprises the steps of: a simulation system linked to a motion system; the simulation system outputting open type command to the motion system; the motion system simultaneously performing operation and analysis on the open type command and platform feedback data by platform dynamic algorithm principle of a controller; the motion system then outputting control signal to a control driver to drive the platform.

Further benefits and advantages of the present invention will become apparent after a careful reading of the detailed description with appropriate reference to the accompanying drawings.

### BRIEF DESCRIPTION OF THE DRAWINGS

FIG. 1 is a flow chart block diagram of a conventional motion/force simulation system having six or three degree of freedom in accordance with the U.S. Pat. No. 5,752,834.

FIG. 2 is a logical architecture block diagram of a control method of an open type motion simulation system of a preferred embodiment of the present invention.

FIG. 3 is a flow chart of the control method of an open type motion simulation system of the preferred embodiment of the present invention.

FIG. 4 is a flow chart of the control layer in the motion system for executing platform dynamic algorithm principle of the preferred embodiment of the present invention.

### DETAILED DESCRIPTION OF THE PREFERRED EMBODIMENTS

Referring initially to the drawings, the control method of an open type motion simulation system in accordance with the present invention is mainly provided with a control ware on the motion system, the control ware includes a platform dynamic algorithm principle to perform operation on the open type command of the simulation system, and the motion system then outputting control signal to a control driver to drive the platform.

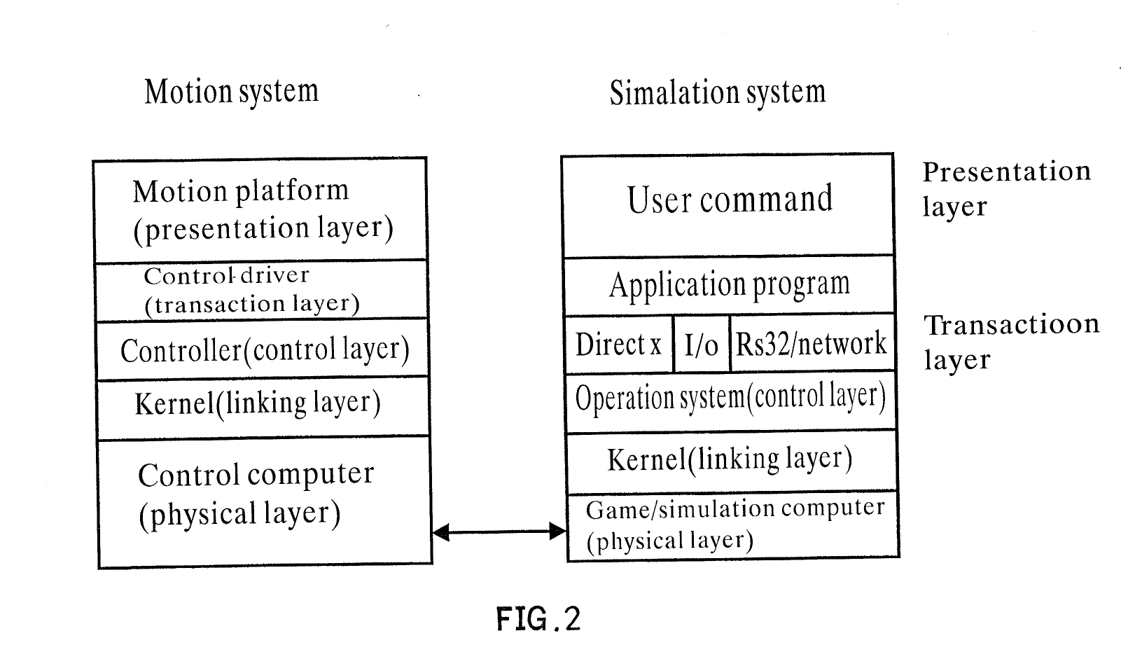

Referring to FIG. 2, which discloses a logical architecture block diagram of a control method of an open type motion simulation system of a preferred embodiment of the present invention. The block diagram mainly includes a simulation system and a motion system. The simulation system is linked to the motion system. The simulation system and motion system on the logic architecture respectively include a presentation layer, a transaction layer, a control layer, a linking layer, and a physical layer. The presentation layer presents physical presentation status to the user; the transaction layer is driving program between operating systems or control programs; the control layer is system resource controlling hardware and application program; the linking layer is kernel driving program linking between hardware architectures; the physical layer is computer hardware.

Again referring to FIG. 2, the presentation layer of the simulation system includes user command and application program. The command is input of user or operation interface, such as rocking lever or steering wheel etc., and the application program is game or simulation program. The transaction layer of the simulation system includes an architecture 3D scene Direct X, and an internet communication interface RS232/NetWork, and an I/O control interface. The control layer of the simulation system is an operation system, such as Windows 98, Windows NT or UNIX. The linking layer of the simulation system is a kernel, such as BIOS. The physical layer of the simulation system is a computer hardware, such as Encore R/T, SGI machine or PC.

Again referring to FIG. 2, the presentation layer of the motion system is a motion platform of 3 to 6 d.o.f. (Degree-of-Freedom). The transaction layer of the motion system is a control driver, such as servo control driver. The control layer of the motion system is a platform dynamic algorithm principle. The linking layer of the motion system is a kernel, such as BIOS. The physical layer of the motion system is a computer hardware, such as Encore R/T, SGI machine or PC and image producer.

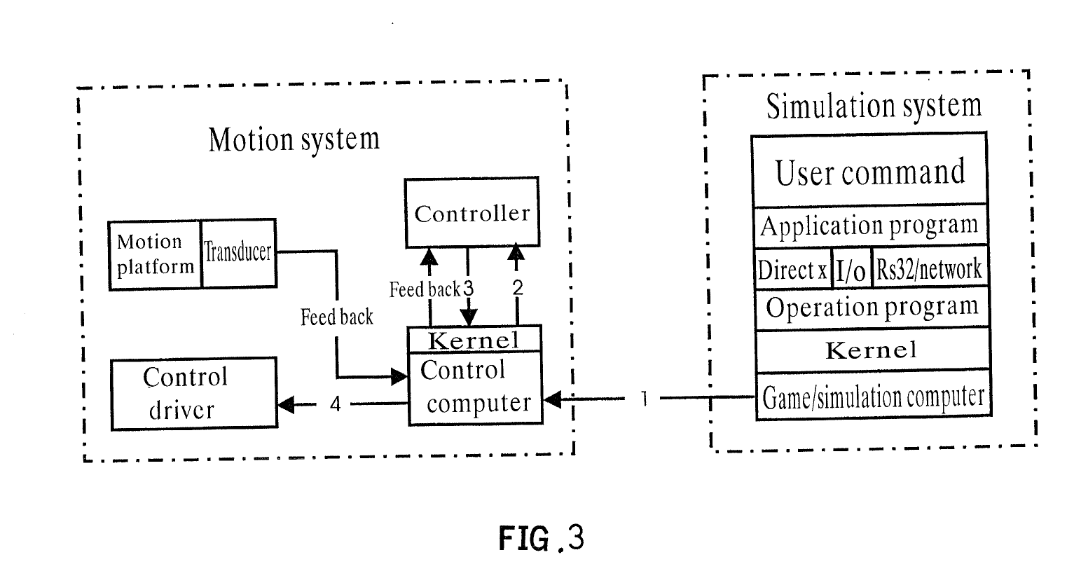

Referring to FIG. 3, which discloses a flow chart of the control method of an open type motion simulation system according to the preferred embodiment of the present invention. The flow chart mainly serially includes a simulation system block, physical layer and linking layer block of motion system, a control layer block of the motion system, a transaction layer block of the motion system, and a presentation layer block of the motion system.

Again referring to FIG. 3, which additionally discloses that the simulation system block outputs open type motion command to the physical layer and linking layer block of the motion system; the physical layer and linking layer block then convert the motion command which is output into the control layer block; the converted motion command is executed through the platform dynamic algorithm principle, the control layer block outputs the control signal into the physical layer and linking layer block; the physical layer and linking layer block then outputs the control signal into the transaction layer block; the transaction layer block then uses the control signal to directly control and drive the motion platform of the presentation layer block; the presentation layer block uses a transducer to return the platform message to the control layer block through the physical layer and linking layer block; the control layer block then uses feedback data and motion command of the platform message, to be executed by the platform dynamic algorithm principle and then outputs control signal. Thus, when the motion system successively receives the open type motion command from the simulation system, the motion system successively executes the physical layer and linking layer block, the control layer block, the transaction layer block, and the presentation layer block. The control method of the present invention between the simulation system and the motion system only needs to build the commonly used open type command of the factors to accomplish the integration.

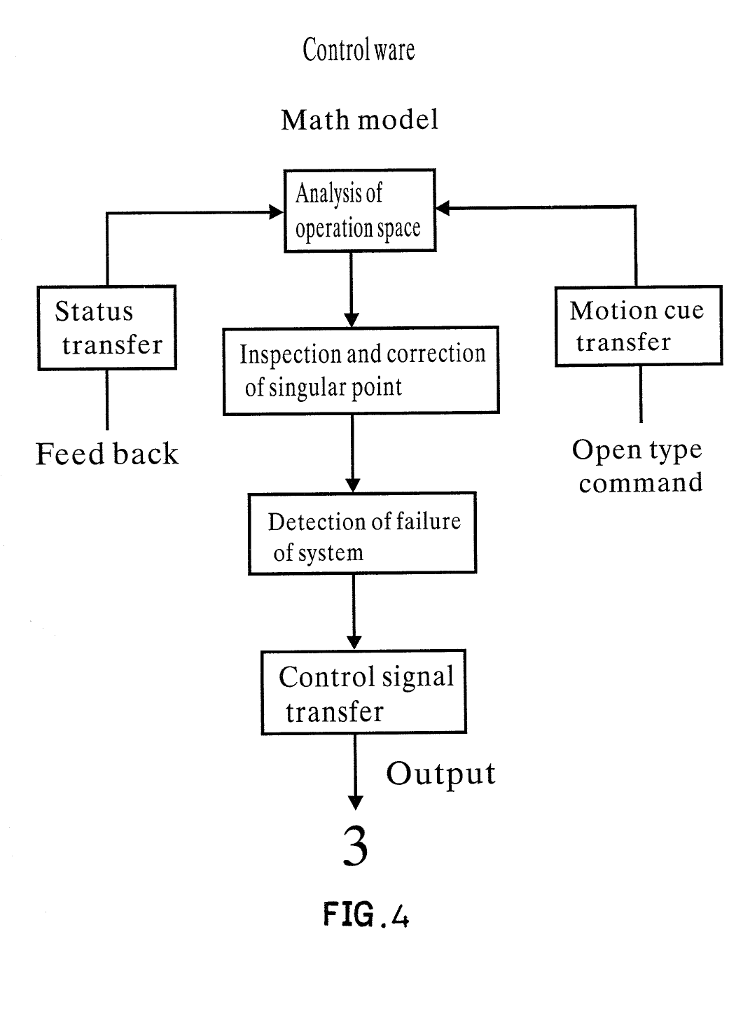

Referring to FIG. 4, which discloses a flow chart of the control layer in the motion system for executing platform dynamic algorithm principle of the preferred embodiment of the present invention. The flow chart of the platform dynamic algorithm principle mainly serially comprises four blocks respectively including a block of analysis of operation space, a block of inspection and correction of singular point, a block of detection of failure of system, and a block of control signal transfer. The four blocks constitute a. math model to execute the operation and comparison analysis. The flow chart is mainly executed in the control layer block of the open type motion simulation system flow chart.

Again referring to FIGS. 3 and 4, the control layer, after the motion command of the simulation system and the feedback signal of the motion platform being input, outputs the control signal to the transaction layer of the motion system through the operation and comparison analysis executed by the math model. The open type motion command of the simulation system is converted into motion signal through a motion cue transfer, and the feedback signal of the motion platform after being converted into status signal through a status transfer, is simultaneously input into the math model of the platform dynamic algorithm principle to execute operation, then outputs the control signal.

Again referring to FIG. 4, the motion signal and status signal are input into the block of analysis of operation space. The block of analysis of operation space, after mutual operation and analysis between the present status and the next step of operation motion, obtains motion command satisfying the motion platform control. The block of inspection and correction of singular point proceeds inspection and correction of the motion command. The block of detection of failure of system, after certifying the system is correct, outputs the motion command into the block of control signal transfer. The block of control signal transfer converts the motion command into the control signal satisfying the motion platform, output to the physical layer and linking layer block, as shown in FIG. 3.

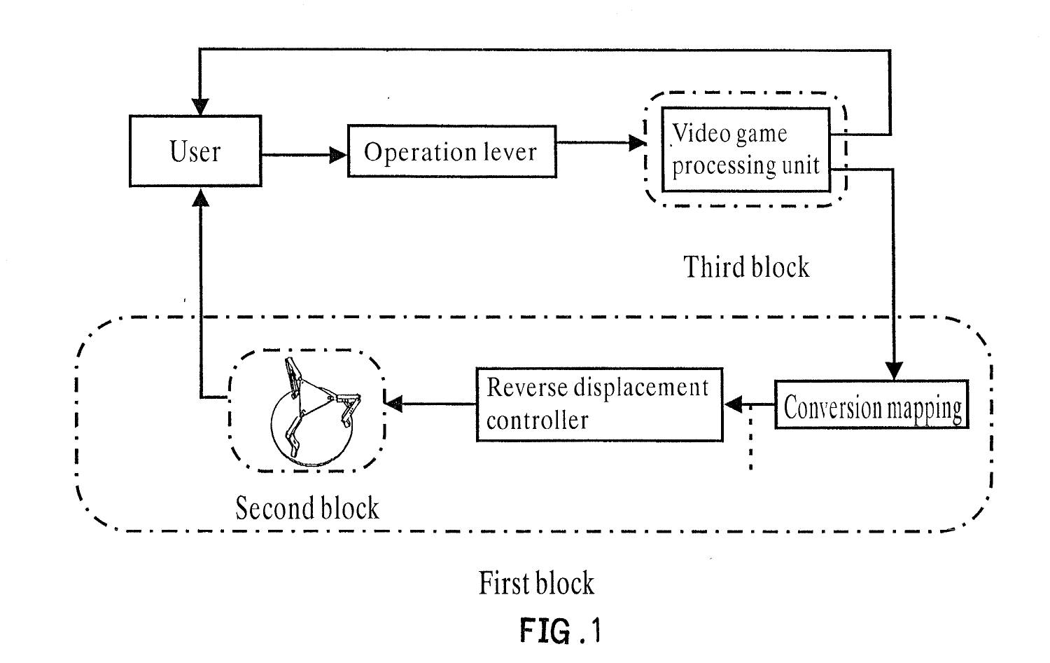

Again referring to FIGS. 1 and 3, the control method of an open type motion simulation system in accordance with the present invention includes a platform dynamic algorithm principle, and the platform dynamic algorithm principle may be used to perform operation and analysis on the open type motion command of various simulation systems to be converted into signal to drive the motion platform of the motion system, thereby building integrated open type command between the simulation system and the motion system of the simulator. Therefore, the program developers only need to especially pay attention to developing the simulating or playing program without having to consider the mating operation of the motion platform, or the factors of the motion system only needs to especially pay attention to developing the motion system without having to consider co-operation of the simulation system. On the contrary, the simulation system of the U.S. Pat. No. 5,752,834 mainly builds the program on the specific static system of image simulation. Thus, the developer of the simulation system cannot amend original simulation program or develop new program especially for the single simulation system of the U.S. Pat. No. 5,752,834. If it needs to amend the original simulation program or to develop the new program, it has to take into consideration of the control of the motion platform, thereby forming the barrier of the program developers.

Although the invention has been explained in relation to its preferred embodiment as mentioned above, it is to be understood that many other possible modifications and variations can be made without departing from the scope of the present invention. It is, therefore, contemplated that the appended claims will cover such modifications and variations that fall within the true scope of the invention.

What is claimed is:

1. A control method of an open type motion simulation system, the method comprising the steps of:
a simulation system linked to a motion system;
the simulation system outputting open type command to the motion system;
the motion system simultaneously performing operation and analysis on the open type command and platform feedback data by platform dynamic algorithm principle of a controller; and
the motion system then outputting control signal to a control driver to drive the platform;
thus building integrated open type command between the simulation system and the motion system.

2. The control method of an open type motion simulation system as claimed in claim 1, wherein the platform dynamic algorithm principle is a math model.

3. The control method of an open type motion simulation system as claimed in claim 1, wherein the open type motion command of the simulation system is converted into motion signal through a motion cue transfer, and the feedback signal of the motion platform after being converted into status signal through a status transfer, is simultaneously input into a math model of the platform dynamic algorithm principle to execute operation, then outputs control signal.

4. The control method of an open type motion simulation system as claimed in claim 1, wherein the simulation system and motion system on the logic architecture respectively include a presentation layer, a transaction layer, a control layer, a linking layer, and a physical layer.

5. The control method of an open type motion simulation system as claimed in claim 4, wherein the flow chart is mainly serially respectively a simulation system block, physical layer and linking layer block of a motion system, a control layer block of the motion system, a transaction layer block of the motion system, and a presentation layer block of the motion system.

6. The control method of an open type motion simulation system as claimed in claim 5, wherein the simulation system block outputs open type motion command to the physical layer and linking layer block of the motion system; the physical layer and linking layer block then convert the motion command which is output into the control layer block; the converted motion command is executed through the platform dynamic algorithm principle, the control layer block outputs the control signal into the physical layer and linking layer block; the physical layer and linking layer block then outputs the control signal into the transaction layer block; the transaction layer block then uses the control signal to directly control and drive the motion platform of the presentation layer block; the presentation layer block uses a transducer to return the platform message to the control layer block through the physical layer and linking layer block; the control layer block then uses feedback data and motion command of the platform message, to be executed by the platform dynamic algorithm principle and then outputs control signal, thus, when the motion system successively receives the open type motion command from the simulation system, the motion system successively executes the physical layer and linking layer block, the control layer block, the transaction layer block, and the presentation layer block.

7. The control method of an open type motion simulation system as claimed in claim 4, wherein the presentation layer of the simulation system includes at least one user command and application program.

8. The control method of an open type motion simulation system as claimed in claim 7, wherein the command is input of user or operation interface, and the application program is game or simulation program.

9. The control method of an open type motion simulation system as claimed in claim 4, wherein the transaction layer of the simulation system includes an architecture 3D scene Direct X, and an internet communication interface RS232/NetWork, and an I/O control interface.

10. The control method of an open type motion simulation system as claimed in claim 4, wherein the control layer of the simulation system is an operation system, such as Windows 98, Windows NT or UNIX.

11. The control method of an open type motion simulation system as claimed in claim 4, wherein the linking layer of the simulation system is a kernel, such as BIOS.

12. The control method of an open type motion simulation system as claimed in claim 4, wherein the physical layer of the simulation system is a computer hardware, such as Encore R/T, SGI machine or PC.

13. The control method of an open type motion simulation system as claimed in claim 4, wherein the presentation layer of the motion system is a motion platform of 3 to 6 d.o.f.

14. The control method of an open type motion simulation system as claimed in claim 4, wherein the transaction layer of the motion system is a control driver, such as servo control driver.

15. The control method of an open type motion simulation system as claimed in claim 4, wherein the control layer of the motion system is a platform dynamic algorithm principle.

16. The control method of an open type motion simulation system as claimed in claim 4, wherein the linking layer of the motion system is a kernel, such as BIOS.

17. The control method of an open type motion simulation system as claimed in claim 4, wherein the physical layer of the motion system is a computer hardware, such as Encore R/T, SGI machine or PC and image producer.

18. The control method of an open type motion simulation system as claimed in claim 1, wherein the flow chart of the platform dynamic algorithm principle is mainly respectively a block of analysis of operation space, a block of inspection and correction of singular point, a block of detection of failure of system, and a block of control signal transfer.

19. The control method of an open type motion simulation system as claimed in claim 18, wherein the motion signal and status signal are input into the block of analysis of operation space, the block of analysis of operation space, after mutual operation and analysis between the present status and the next step of operation motion, obtains motion command satisfying the motion platform control; the block of inspection and correction of singular point proceeds inspection and correction of the motion command; the block of detection of failure of system, after certifying the system is correct, outputs the motion command into the block of control signal transfer; the block of control signal transfer converts the motion command into control signal satisfying the motion platform.
